(19) United States
(12) Patent Application Publication
(10) Pub. No.: US 2023/0240467 A1
(43) Pub. Date: Aug. 3, 2023

(54) TEA LEAF AND WATER SEPARATION CUP

(71) Applicant: Fuxing Feng, Ningjin (CN)

(72) Inventor: Fuxing Feng, Ningjin (CN)

(21) Appl. No.: 18/299,103

(22) Filed: Apr. 12, 2023

(30) Foreign Application Priority Data
Aug. 9, 2022 (CN) 202210952655.3

(51) Int. Cl. A47J 31/20; A47J 31/44; A47J 31/46; A47J 31/06

(52) U.S. Cl. CPC A47J 31/20; A47J 31/446; A47J 31/467; A47J 31/0636

(57) ABSTRACT

The present disclosure discloses a tea leaf and water separation cup, and relates to the field of tea cups. The tea leaf and water separation cup includes a cup body and a lid; the lip is mounted on the cup body through threads; a plurality of anti-skid slots are formed in the lid; an upper tea leaf chamber and a lower tea leaf chamber are arranged in the cup body; and the lower tea leaf chamber is fastened to the upper tea leaf chamber. In the present disclosure, the upper tea leaf chamber and the lower tea leaf chamber can be adsorbed to the lid by using an attractive force of a magnet, and are conveniently separated from the lid, so that the tea leaf chambers can be connected to the lid in an attracting manner.

### TECHNICAL FIELD

The present disclosure relates to the technical field of tea cups, in particular to, a tea leaf and water separation cup.

### BACKGROUND

In China, most people like to drink tea in their daily life. Tea leaves can change the taste of water, making the water taste a fragrance of the tea leaves. Tea cups are utensils for holding tea water. Tea water is poured into a tea cup from a teapot, and guests can taste the tea. In real life, a tea cup is generally composed of a lid and a cup body. To make tea, tea leaves are put into the tea cup, and boiled water is then poured into the tea cup. Since the tea cup is portable, a user can directly tighten the lid, hold the tea cup and go out.

In the prior art, however, for the existing tea cups, tea leaves are usually directly put into a cup body. This method for making tea will cause the tea leaves to be adhered to an inner wall of the cup body and difficult to remove. When people drink the tea, the tea leaves easily enter the mouth. Therefore, a tea leaf and water separation cup is needed to meet demands of people.

### SUMMARY

The present disclosure aims to provide a tea leaf and water separation cup, to solve the problems mentioned in the above background: For existing tea cups, tea leaves are usually directly put into a cup body. This method for making tea will cause the tea leaves to be adhered to an inner wall of the cup body and difficult to remove. When people drink the tea, the tea leaves easily enter the mouth.

In order to achieve the above objective, the present disclosure provides the following technical solution: A tea leaf and water separation cup includes a cup body and a lid; the lid is mounted on the cup body through threads; a plurality of anti-skid slots are formed in the lid; an upper tea leaf chamber and a lower tea leaf chamber are arranged in the cup body; the lower tea leaf chamber is fastened to the upper tea leaf chamber; a plurality of water leaking holes are formed in the upper tea leaf chamber and the lower tea leaf chamber; the lip is movably provided with a control sleeve in an internal rotatable manner; an attracting magnet is arranged in the control sleeve; a magnet is arranged in the upper tea leaf chamber; and the magnet attracts the attracting magnet.

Preferably, a dustproof cover is movably mounted on the lid; a hidden handle is rotatably mounted on the dustproof cover; a rotating support is fixedly mounted on the hidden handle; two ends of the rotating support are fixedly provided with supporting shafts; two supporting seats are fixedly mounted on the lid; and the two supporting shafts are rotatably mounted on the two supporting seats respectively.

Preferably, a fastening slot is annularly formed in the hidden handle; a fastening ring is annularly fixedly mounted on the dustproof cover; and the fastening ring is fastened in the fastening slot.

Preferably, a mounting sheet is arranged in the lid; a retainer ring is fixedly mounted on a bottom side of the mounting sheet; a clamping slot is formed in the lid; and the retainer ring is clamped in the clamping slot.

Preferably, a pipe for drinking water is fixedly mounted on the mounting sheet; an air vent is formed in the mounting sheet; an air guide column is fixedly mounted on the lid; the air guide column is matched with the air vent; a silica gel plug and a silica gel plug for mouth piece are fixedly mounted on a bottom side of the dustproof cover; and the silica gel plug and the silica gel plug for mouth piece are matched with the air vent and the pipe for drinking water.

Preferably, lock catch sleeves are fixedly mounted on the lid and the dustproof cover; a safety lock catch capable of preventing water leakage is movably mounted in the lock catch sleeve located on the lid; a clamping piece is clamped to the safety lock catch capable of preventing water leakage; a clamping slot is formed in the dustproof cover; and the clamping piece is clamped in the clamping slot.

Preferably, a rotating seat is fixedly mounted on the lid; a rotating piece is fixedly mounted on the safety lock catch capable of preventing water leakage; the rotating piece is movably mounted on a rotating seat; a lock catch shaft is rotatably mounted on the lock catch sleeve located on the lid; two movable holes are formed in the rotating piece; and the lock catch shaft penetrates through the two movable holes in sequence.

Preferably, a balancing weight is embedded in the upper tea leaf chamber; the balancing weight is made of a stainless steel material; the magnet is located between the balancing weight and the upper tea leaf chamber; an attracting slot is formed in a top side of the upper tea leaf chamber; an attracting ring is fixedly mounted on a bottom side of the lid; and the attracting ring is plugged in the attracting slot.

Preferably, a rotating hole and a magnet slot are formed in the control sleeve; the attracting magnet is embedded in the magnet slot; a fixed shaft is rotatably mounted in the rotating hole; the fixed shaft is fixedly mounted on the lid; a guide sleeve is fixedly mounted on the lid; a guide slot is formed in the guide sleeve; and the control sleeve is movably mounted in the guide slot.

Preferably, a hole for opening is formed in the lid; one side of the control sleeve penetrates through the hole for opening; a baffle plate is fixedly mounted on the control sleeve; and the baffle plate is in contact with an inner wall of the lid.

The present disclosure has the beneficial effects:

In the present disclosure, the upper tea leaf chamber and the lower tea leaf chamber can be adsorbed to the lid by using an attractive force of a magnet, and are conveniently separated from the lid, so that the tea leaf chambers can be connected to the lid in an attracting manner. To make tea, the tea leaf chambers can sink to the bottom of the cup, so that tea leaves can be fully immersed in water. The tea brewing time can be adjusted according to personal tastes. If it is not necessary to immerse the tea leaf chamber in the water, the cup can be placed upside down vertically. When the tea leaf chamber is in close contact with the lid, the tea leaf chamber can be automatically connected to the lid in the attracting manner. The function can effectively prevent the phenomenon that the taste is affected because strong tea is made after the tea leaves are immersed for long time, and the purpose of tea leaf and water separation is achieved.

In the present disclosure, by the arrangement of the dustproof cover, the pipe for drinking water, the safety lock catch capable of preventing water leakage, and the hidden handle, the dustproof cover can ensure the cleanness of the pipe for drinking water; it is convenient for people to drink tea with the pipe for drinking water; the safety lock catch capable of preventing water leakage can fix the dustproof cover; and it is convenient to carry the cup with the hidden handle, so that the cup is more convenient to use and further meets diversified demands of people.

### BRIEF DESCRIPTION OF THE DRAWINGS

FIG. 1 is a schematic diagram of a back structure of a tea leaf and water separation cup provided in the present disclosure;

FIG. 2 is a schematic diagram of a three-dimensional structure of a tea leaf and water separation cup provided in the present disclosure;

FIG. 3 is a schematic diagram of a sectional structure of connection between a lid and an upper tea leaf chamber as well as a lower tea leaf chamber of a tea leaf and water separation cup provided in the present disclosure;

FIG. 4 is a schematic diagram of a sectional structure of a tea leaf and water separation cup provided in the present disclosure;

FIG. 5 is a schematic structural diagram of the portion A of the tea leaf and water separation cup provided in the present disclosure in FIG. 4;

FIG. 6 is a schematic structural diagram of connection between an upper tea leaf chamber and a lower tea leaf chamber of a tea leaf and water separation cup provided in the present disclosure;

FIG. 7 is a schematic diagram of an internal structure of a lid of a tea leaf and water separation cup provided in the present disclosure; and

FIG. 8 is a schematic structural diagram of a safety lock catch capable of preventing water leakage of a tea leaf and water separation cup provided in the present disclosure, in which an adapter pipe and a feed pipe are connected.

In the drawings: 1: cup body; 2: lid; 3: upper tea leaf chamber; 4: lower tea leaf chamber; 5: magnet; 6: balancing weight; 7: attracting magnet; 8: control sleeve; 9: baffle plate; 10: dustproof cover; 11: hidden handle; 12: mounting sheet; 13: air vent; 14: silica gel plug; 15: pipe for drinking water; 16: silica gel plug for mouth piece; 17: lock catch sleeve; 18: safety lock catch capable of preventing water leakage; 19: lock catch shaft; 20: clamping piece; 21: clamping slot; 22: rotating support; 23: hole for opening; 24: rotating hole; 25: fixed shaft; 26: anti-skid slot; 27: guide sleeve; 28: guide slot; 29: supporting seat; 30: supporting shaft; 31: attracting slot; 32: attracting ring; 33: clamping slot; 34: retainer ring; 35: magnet slot; 36: rotating seat; 37: rotating piece; 38: movable hole; 39: fastening slot; 40: fastening ring; 41: water leaking hole; and 42: air guide column.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments.

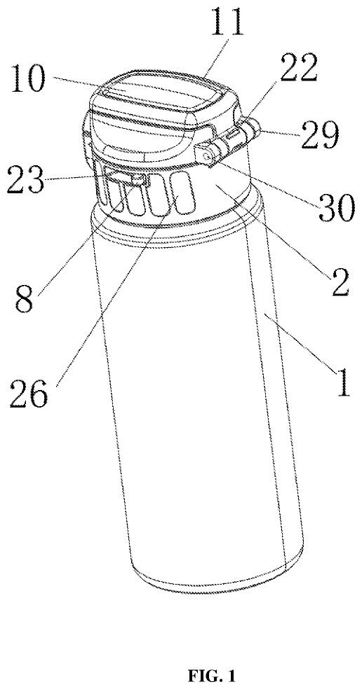

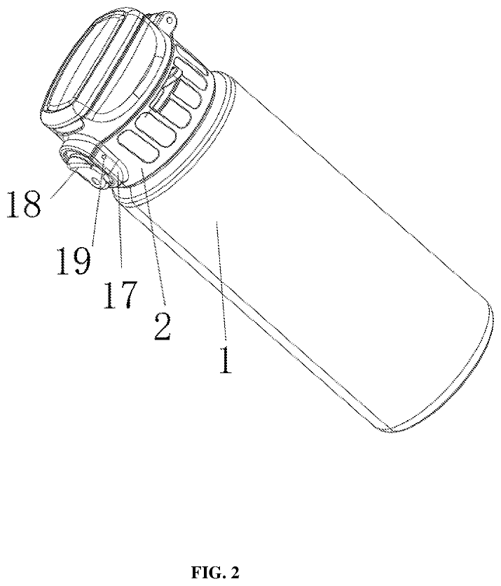

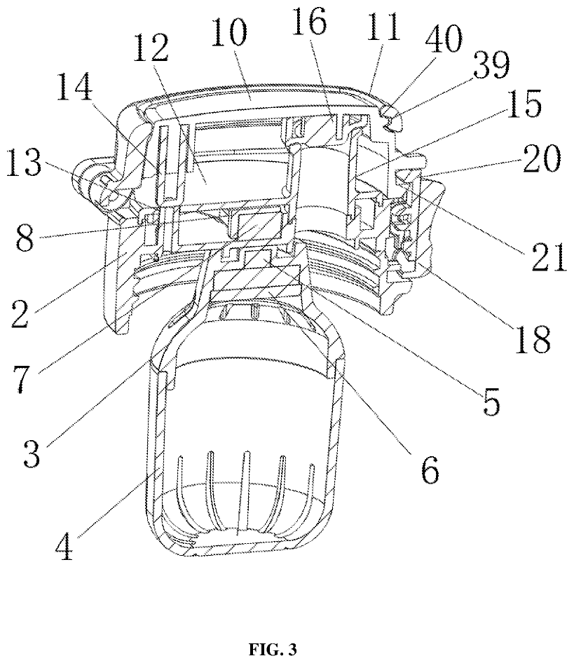

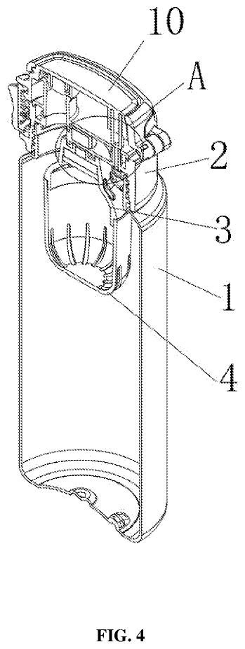

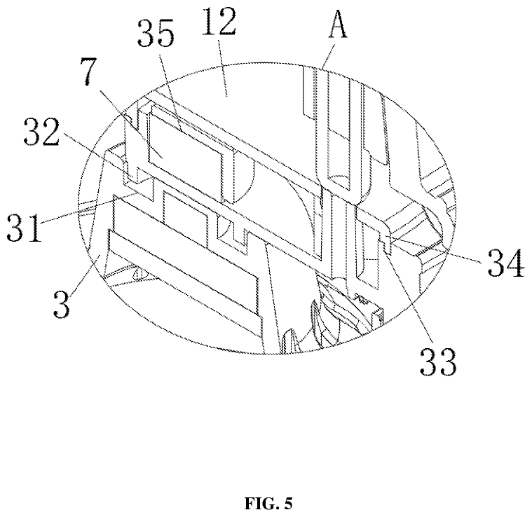

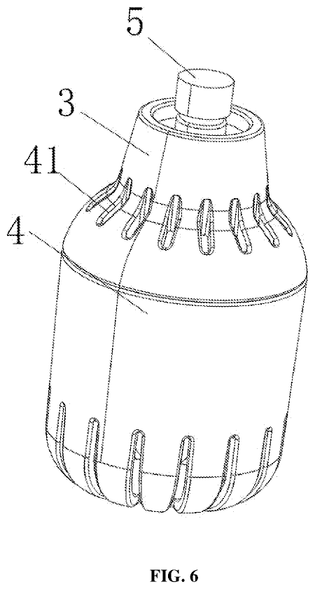

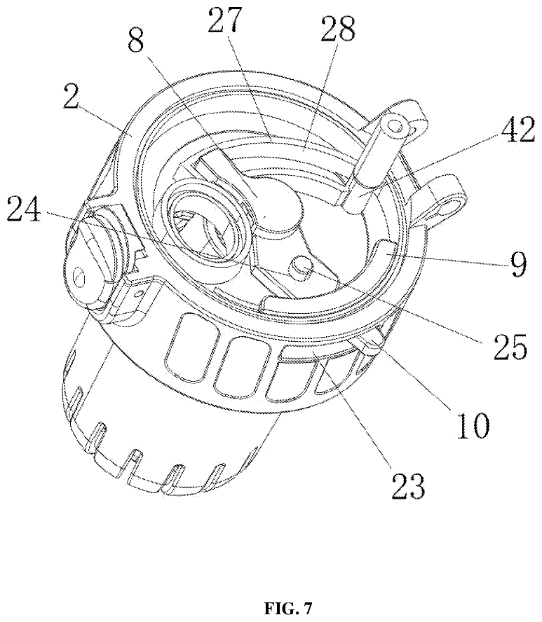

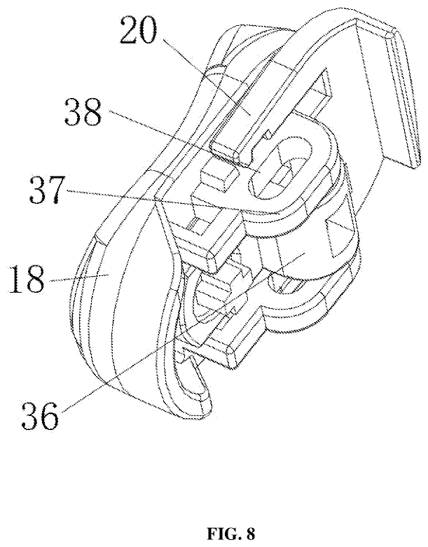

Referring to FIG. 1 to FIG. 8, a tea leaf and water separation cup includes a cup body 1 and a lid 2. The lid 2 is mounted on the cup body 1 through threads. A plurality of anti-skid slots 26 are formed in the lid 2. An upper tea leaf chamber 3 and a lower tea leaf chamber 4 are arranged in the cup body 1. The lower tea leaf chamber 4 is fastened to the upper tea leaf chamber 3. A plurality of water leaking holes 41 are formed in the upper tea leaf chamber 3 and the lower tea leaf chamber 4. The lip 2 is movably provided with a control sleeve 8 in an internal rotatable manner. An attracting magnet 7 is arranged in the control sleeve 8. A magnet 5 is arranged in the upper tea leaf chamber 3. The magnet 5 attracts the attracting magnet 7. A dustproof cover 10 is movably mounted on the lid 2. A hidden handle 11 is rotatably mounted on the dustproof cover 10. A rotating support 22 is fixedly mounted on the hidden handle 11. Two ends of the rotating support 22 are fixedly provided with supporting shafts 30. Two supporting seats 29 are fixedly mounted on the lid 2. The two supporting shafts 30 are rotatably mounted on the two supporting seats 29 respectively. A balancing weight 6 is embedded in the upper tea leaf chamber 3. The balancing weight 6 is made of a 304 stainless steel material. The magnet 5 is located between the balancing weight 6 and the upper tea leaf chamber 3. An attracting slot 31 is formed in a top side of the upper tea leaf chamber 3. An attracting ring 32 is fixedly mounted on a bottom side of the lid 2. The attracting ring 32 is plugged in the attracting slot 31. A rotating hole 24 and a magnet slot 35 are formed in the control sleeve 8. The attracting magnet 7 is embedded in the magnet slot 35. A fixed shaft 25 is rotatably mounted in the rotating hole 24. The fixed shaft 25 is fixedly mounted on the lid 2. A guide sleeve 27 is fixedly mounted on the lid 2. A guide slot 28 is formed in the guide sleeve 27. The control sleeve 8 is movably mounted in the guide slot 28. A hole 23 for opening is formed in the lid 2. One side of the control sleeve 8 penetrates through the hole 23 for opening. A baffle plate 9 is fixedly mounted on the control sleeve 8. The baffle plate 9 is in contact with an inner wall of the lid 2. The attracting magnet 7 is added on the lid 2, so that the upper tea leaf chamber 3 can be connected to the lid 2 in an attracting manner. To make tea, the control sleeve 8 is pushed to be able to rotate by taking the fixed shaft 25 as a pivot. Meanwhile, one side of the control sleeve 8 rotates along the guide slot 28, so that the control sleeve 8 can control the attracting magnet 7 to rotate and separate the attracting magnet 7 from the magnet 5. At this time, the upper tea leaf chamber 3 will sink to the bottom of the cup as a magnetic force between it and the lid 2 is lost. The 304 stainless steel balancing weight 6 is added in the upper tea leaf chamber 3 to increase the weight of the tea leaf chamber, and the tea leaf chamber sinks to the bottom of the cup quickly, so that the tea leaves can be fully immersed in water. The magnet and the 304 stainless steel are wrapped by food-grade plastic completely and hermetically, and will not be in contact with the drinking water in the cup body, so that no harmful substances are generated. In addition, the tea leaves will not be adhered to an inner wall of the cup body, and the tea brewing time can be adjusted according to personal tastes. If it is not necessary to immerse the tea leaf chamber in the water, the cup can be placed upside down vertically. When the tea leaf chamber is in close contact with the lid 2, the tea leaf chamber can be automatically connected to the lid 2 in the attracting manner. The function can effectively prevent the phenomenon that the taste is affected because strong tea is made after the tea leaves are immersed for long time, and the purpose of tea leaf and water separation is achieved.

Referring to FIG. 1 to FIG. 8, a fastening slot 39 is annularly formed in the hidden handle 11. A fastening ring 40 is annularly fixedly mounted on the dustproof cover 10. The fastening ring 40 is fastened in the fastening slot 39. A mounting sheet 12 is arranged in the lid 2. A retainer ring 34 is fixedly mounted on a bottom side of the mounting sheet 12. A clamping slot 33 is formed in the lid 2. The retainer ring 34 is clamped in the clamping slot 33. A pipe 15 for drinking water is fixedly mounted on the mounting sheet 12. An air vent 13 is formed in the mounting sheet 12. An air guide column 42 is fixedly mounted on the lid 2. The air guide column 42 is matched with the air vent 13. A silica gel plug 14 and a silica gel plug 16 for mouth piece are fixedly mounted on a bottom side of the dustproof cover 10. The silica gel plug 14 and the silica gel plug 16 for mouth piece are matched with the air vent 13 and the pipe 15 for drinking water. Lock catch sleeves 17 are fixedly mounted on the lid 2 and the dustproof cover 10. A safety lock catch 18 capable of preventing water leakage is movably mounted in the lock catch sleeve 17 located on the lid 2. A clamping piece 20 is clamped to the safety lock catch 18 capable of preventing water leakage; a clamping slot 21 is formed in the dustproof cover 10. The clamping piece 20 is clamped in the clamping slot 21. A rotating seat 36 is fixedly mounted on the lid 2. A rotating piece 37 is fixedly mounted on the safety lock catch 18 capable of preventing water leakage. The rotating piece 37 is movably mounted on a rotating seat 36. A lock catch shaft 19 is rotatably mounted on the lock catch sleeve 17 located on the lid 2. Two movable holes 38 are formed in the rotating piece 37. The lock catch shaft 19 penetrates through the two movable holes 38 in sequence. By the arrangement of the hidden handle 11, the whole cup body 1 can be conveniently lifted up, which is convenient to hold. Meanwhile, the hidden handle 11 can be stored on the dustproof cover 10. The hidden handle will not take a large space when not in use. Furthermore, the pipe 15 for drinking water is arranged on the mounting sheet 12. In this way, people can drink water conveniently after opening the dustproof cover 10. In addition, by the arrangement of the safety lock catch 18 capable of preventing water leakage, when the dustproof cover 10 needs to be opened, the safety lock catch 18 capable of preventing water leakage is pressed to make the clamping piece 20 rotate. In addition, the clamping piece 20 rotates and slides on the lock catch shaft 19 through the two movable holes 38. In this way, the clamping piece 20 can be separated from the clamping slot 21, and the dustproof cover 10 can be conveniently opened at this time.

The working principle of the present disclosure is as follows:

To make tea, the control sleeve 8 is first pushed to rotate in the hole 23 for opening. Meanwhile, the control sleeve 8 moves to drive the baffle plate 9 to move, and the control sleeve 8 then rotate on the fixed shaft 25 through the rotating hole 24. In addition, the control sleeve 8 moves in the guide sleeve 28. These actions can limit the control sleeve 8 to only rotate by taking the fixed shaft 25 as a center. The control sleeve 8 can rotate to drive the attracting magnet 7 to rotate, finally making the attracting magnet 7 be separated from the magnet 5. At this time, the upper tea leaf chamber 3 will sink as a magnetic force between it and the lid 2 is lost. Sinking of the upper tea leaf chamber 3 can drive the lower tea leaf chamber 4 to sink. Furthermore, the 304 stainless steel balancing weight 6 is added in the upper tea leaf chamber 3 to increase the weight of the tea leaf chamber, and the upper tea leaf chamber 3 and the lower tea leaf chamber 4 can sink to the bottom of the cup quickly, so that the tea leaves can be fully immersed in water. The magnet 5, the attracting magnet and the 304 stainless steel balancing weight 6 are wrapped by food-grade plastic completely and hermetically, and will not be in contact with the drinking water in the cup body, so that no harmful substances are generated. In addition, the tea leaves will not be adhered to an inner wall of the cup body, and the tea brewing time can be adjusted according to personal tastes. If it is not necessary to immerse the tea leaf chamber in the water, the cup can be placed upside down vertically. When the tea leaf chamber is in close contact with the lid 2, the tea leaf chamber can be automatically connected to the lid 2 in the attracting manner. The function can effectively prevent the phenomenon that the taste is affected because strong tea is made after the tea leaves are immersed for long time, and the purpose of tea leaf and water separation is achieved.

The above descriptions are only specific preferred implementation modes of the present disclosure, but the scope of protection of the present disclosure is not limited thereto. For any person skilled in the art, within the technical scope disclosed by the present disclosure, equivalent substitutions or changes made according to the technical solution of the present disclosure and an inventive idea of the present disclosure shall all fall within the scope of protection of the present disclosure.

What is claimed is:

1. A tea leaf and water separation cup, comprising a cup body (1) and a lid (2), wherein the lid (2) is mounted on the cup body (1) through threads; a plurality of anti-skid slots (26) are formed in the lid (2); an upper tea leaf chamber (3) and a lower tea leaf chamber (4) are arranged in the cup body (1); the lower tea leaf chamber (4) is fastened to the upper tea leaf chamber (3); a plurality of water leaking holes (41) are formed in the upper tea leaf chamber (3) and the lower tea leaf chamber (4); the lip (2) is movably provided with a control sleeve (8) in an internal rotatable manner; an attracting magnet (7) is arranged in the control sleeve (8); a magnet (5) is arranged in the upper tea leaf chamber (3); and the magnet (5) attracts the attracting magnet (7).

2. The tea leaf and water separation cup according to claim 1, wherein a dustproof cover (10) is movably mounted on the lid (2); a hidden handle (11) is rotatably mounted on the dustproof cover (10); a rotating support (22) is fixedly mounted on the hidden handle (11); two ends of the rotating support (22) are fixedly provided with supporting shafts (30); two supporting seats (29) are fixedly mounted on the lid (2); and the two supporting shafts (30) are rotatably mounted on the two supporting seats (29) respectively.

3. The tea leaf and water separation cup according to claim 2, wherein a fastening slot (39) is annularly formed in the hidden handle (11); a fastening ring (40) is annularly fixedly mounted on the dustproof cover (10); and the fastening ring (40) is fastened in the fastening slot (39).

4. The tea leaf and water separation cup according to claim 1, wherein a mounting sheet (12) is arranged in the lid (2); a retainer ring (34) is fixedly mounted on a bottom side of the mounting sheet (12); a clamping slot (33) is formed in the lid (2); and the retainer ring (34) is clamped in the clamping slot (33).

5. The tea leaf and water separation cup according to claim 4, wherein a pipe (15) for drinking water is fixedly mounted on the mounting sheet (12); an air vent (13) is formed in the mounting sheet (12); an air guide column (42) is fixedly mounted on the lid (2); the air guide column (42) is matched with the air vent (13); a silica gel plug (14) and a silica gel plug (16) for mouth piece are fixedly mounted on a bottom side of the dustproof cover (10); and the silica gel plug (14) and the silica gel plug (16) for mouth piece are matched with the air vent (13) and the pipe (15) for drinking water.

6. The tea leaf and water separation cup according to claim 1, wherein lock catch sleeves (17) are fixedly mounted on the lid (2) and the dustproof cover (10); a safety lock catch (18) capable of preventing water leakage is movably mounted in the lock catch sleeve (17) located on the lid (2); a clamping piece (20) is clamped to the safety lock catch (18) capable of preventing water leakage; a clamping slot (21) is formed in the dustproof cover (10); and the clamping piece (20) is clamped in the clamping slot (21).

7. The tea leaf and water separation cup according to claim 6, wherein a rotating seat (36) is fixedly mounted on the lid (2); a rotating piece (37) is fixedly mounted on the safety lock catch (18) capable of preventing water leakage; the rotating piece (37) is movably mounted on a rotating seat (36); a lock catch shaft (19) is rotatably mounted on the lock catch sleeve (17) located on the lid (2); two movable holes (38) are formed in the rotating piece (37); and the lock catch shaft (19) penetrates through the two movable holes (38) in sequence.

8. The tea leaf and water separation cup according to claim 1, wherein a balancing weight (6) is embedded in the upper tea leaf chamber (3); the balancing weight (6) is made of a 304 stainless steel material; the magnet (5) is located between the balancing weight (6) and the upper tea leaf chamber (3); an attracting slot (31) is formed in a top side of the upper tea leaf chamber (3); an attracting ring (32) is fixedly mounted on a bottom side of the lid (2); and the attracting ring (32) is plugged in the attracting slot (31).

9. The tea leaf and water separation cup according to claim 1, wherein a rotating hole (24) and a magnet slot (35) are formed in the control sleeve (8); the attracting magnet (7) is embedded in the magnet slot (35); a fixed shaft (25) is rotatably mounted in the rotating hole (24); the fixed shaft (25) is fixedly mounted on the lid (2); a guide sleeve (27) is fixedly mounted on the lid (2); a guide slot (28) is formed in the guide sleeve (27); and the control sleeve (8) is movably mounted in the guide slot (28).

10. The tea leaf and water separation cup according to claim 1, wherein a hole (23) for opening is formed in the lid (2); one side of the control sleeve (8) penetrates through the hole (23) for opening; a baffle plate (9) is fixedly mounted on the control sleeve (8); and the baffle plate (9) is in contact with an inner wall of the lid (2).
